(19) United States
(12) Patent Application Publication
(10) Pub. No.: US 2003/0180700 A1
(43) Pub. Date: Sep. 25, 2003

(54) Method and system for a user controlled educational program utilized over a network

(76) Inventors: Timothy Barry, Chicago, IL (US); Guy Gunzberg, Evanston, IL (US); Paul Manzano, Chicago, IL (US); Michael Wasserman, Vienna, VA (US)

Correspondence Address: Paul F. Manzano, 446 North Wells Street, #310, Chicago, IL, 60610, US

(21) Appl. No.: 10/104,530

(22) Filed: Mar. 21, 2002

(51) Int. Cl. G09B 3/00

(52) U.S. Cl. 434/350; 434/169

(57) ABSTRACT

A user-controlled network based learning system allows the user to select an appropriate learning method for the user, as well as the material relevant to the user, to maximize the learning experience for the user. The system provides a mechanism for information sharing within, and out of, the learning system. Upon deciding to participate in a learning lesson, the user first determines whether to participate in an already developed learning lesson, or to create their own learning lesson based on the breakdown of previously developed learning lessons and criteria the user determines relevant to their desired learning objective. Upon selection of the lesson, the user then determines an appropriate learning method in which to conduct the learning lesson. Based on the selection of the learning method, the user will again determine the information relevant to their desired learning objective. Within the learning system, the user may share information across the population of users in the learning system, as well as other defined individuals outside of the learning system. Upon completion of individual learning lessons, the learning system provides tools to monitor, for any period of time, user implementation of key lessons learned into daily requirements.

### FIELD OF THE INVENTION

The present invention generally relates to learning systems, and more particularly relates to a user-controlled network-based learning system and method.

### BACKGROUND

The advancement of computer network technologies has made it possible to deliver educational services to different locations at the same time via networks such as computer networks. Systems developed for this purpose are commonly referred to as distance learning systems or network-based learning systems.

Some known network-based learning systems incorporate asynchronous and synchronous methods of utilizing text, computer graphics, or video. Many of these systems develop material to be learned by participants in the learning system and typically push the information onto the learner, a one size fits all approach. Upon completion of the information, or lesson, participants are assessed to their level of retention for the material presented in the lesson. Alternatively, other learning systems gather information about the user, then establish a learning objective and gear a learning lesson based on the information provided by the learner. Once again, these systems push the information onto the learner after initially determining the relevant material for the learner. These systems may also provide feedback. The instructor may monitor the performance of the learner while the learner is participating in the learning lesson.

These systems, however, provide for incomplete learning opportunities.

### BRIEF SUMMARY

The system and method allows a user, e.g., a learner, to customize a learning lesson and/or track comprehension of the learning lesson. In one aspect, the user can select a learning method as well as the material relevant to the user, to help maximize the learning experience for the user. The system and method may also provide a mechanism for information sharing within, and out of, the learning system. The user may determine whether to participate in an already developed learning lesson, or to create a learning lesson based on previously developed learning lessons and criteria the user determines relevant to a desired learning objective. After choosing the lesson, the user, or other individual, can also monitor the user's understanding of the learning lesson during, upon completion of, and even some time after completion of, the learning lesson.

In one aspect, there is provided a network-based learning system that allows learning lessons to be delivered via a computer network. The learning system preferably includes text and video lectures and background information to supplement user understanding of material. The learning system also preferably includes feedback mechanisms in the form of exams and surveys, and communication methods like chat, threaded discussion, and individual and mass email.

The above and other features and advantages will become apparent from the following description when taken in conjunction with the accompanying drawings.

### BRIEF DESCRIPTION OF THE DRAWINGS

FIG. 1 is a block diagram of an exemplary system for network-based learning according to a preferred embodiment.

FIG. 2 is a block diagram illustrating a control map for the user-controlled network based learning system according to a preferred embodiment.

FIG. 3 is a diagram demonstrating divisional learning lessons and compartmentalization in the database to allow the user to customize a learning lesson.

FIG. 4 is a diagram of the screen or display area where the user can input specific criteria in order to create a learning lesson.

FIG. 5 is a diagram demonstrating the options a user is presented after inputting their specific criteria to create the learning lesson.

FIG. 6 is a diagram that demonstrates one embodiment of the user's ability to select a learning lesson from an archive of prior learning lessons.

FIG. 7 is an exemplary computer terminal screen shot of choices the user can make to determine which learning method is preferred for a particular learning lesson.

FIG. 8 is a diagram demonstrating one embodiment of the learning lesson if the user selects to learn via reading.

FIG. 9 is a diagram demonstrating one embodiment of the learning lesson if the user selects to learn via a passive audio and/or video stimulus.

FIG. 10 is a diagram illustrating one embodiment of an interactive, or full, learning experience if the user selects to learn via this approach.

### DETAILED DESCRIPTION

The present system and method provide a user-controlled network based learning system that allows the user, e.g., learner, to select a desired learning method at entry points in the learning lesson. The system and method can also allow the user to control the material presented in the learning lesson to achieve the user's desired learning objective. In addition, the user can customize a learning lesson based on criteria they develop to achieve a specific learning objective. The user, or other individual, can also monitor the user's understanding of the learning lesson during, upon completion of, and even some time after completion of, the learning lesson.

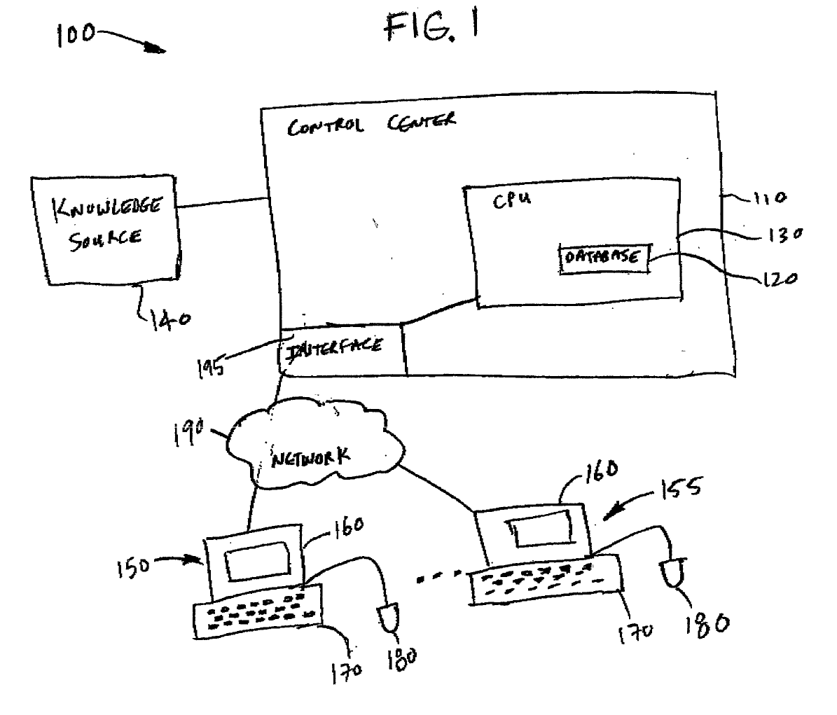

FIG. 1 is a block diagram illustrating an exemplary network 100 that supports a learning system. The network 100 includes a control center 110 for gathering and storing information, such as educational information. The control center 110 preferably includes a database 120 to store the information. The database 120 can be part of a central processing unit 130, such as a personal computer, a laptop, server or a mainframe computer. The central processing unit 130 can be a stand alone unit, or part of a network of units.

Information stored in the database 120 is gathered from a source, such as, a knowledge source 140. In one embodiment, knowledge sources 140 include corporate executives sharing their experiences to provide experience-based training. The knowledge source can also include others, such as educators, students, and/or other system users. A system user preferably accesses the information via a user terminal 150, and other system users may access the information with other user terminals 155. The user terminals 150, 155 preferably include a monitor 160 and input devices, such as keypad 170 and/or a mouse 180.

The user terminals 150, 155 communicate with the database 120 via a communication system such as network 190. In one embodiment, the network 190 includes a packet-based data network, such as the Internet and/or a telecommunication network, with either wireless or wire line communication capabilities. Non-packet based networks may be used, such as dedicated direct connections. The network 190 connects to an interface 195 at the control center 110, which may be included with the central processing unit 130.

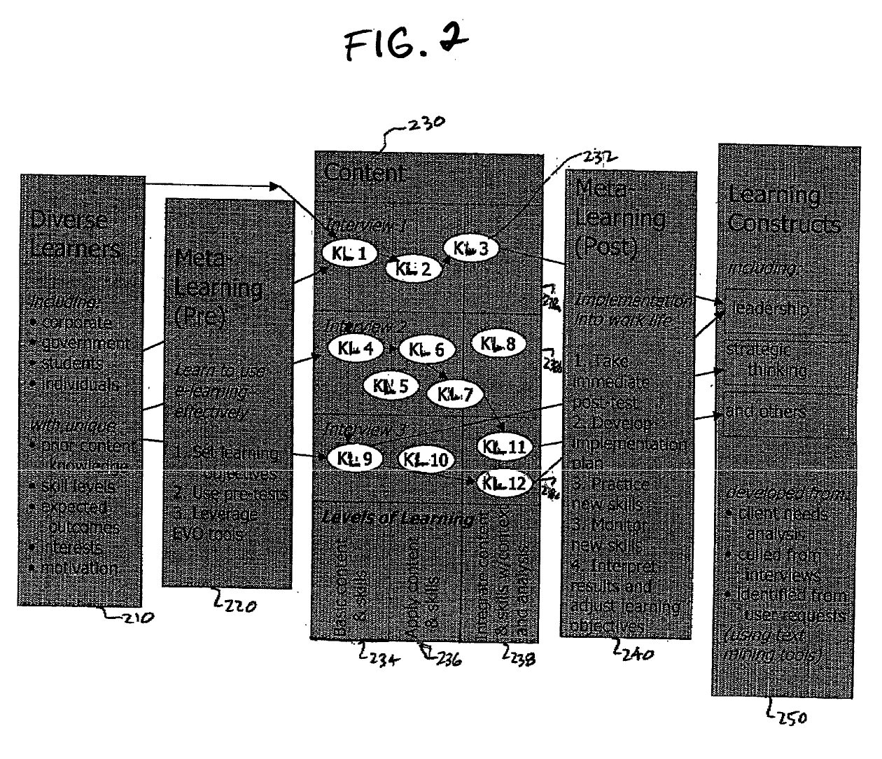

FIG. 2 is a block diagram illustrating a control map 200 for the user-controlled network based learning system according to a preferred embodiment. At block 210, for the purpose of explaining the preferred embodiments, the users include a variety of learners such as corporate employees, government workers and students. It should be appreciated, however, that anyone could use the system. The learners could have different existing knowledge, unique skill levels and varying expected outcomes, interests and motivations.

At block 220, phase I of the control map 200 includes the user learning how to use the learning system effectively. To use the learning system, the user may set learning objectives, participate in pre-learning testing and identify the different learning tools, such as text or video tools described below. At block 230, the learning tools allow the user to control the access to information from the database 120. The information contained in the database is preferably parsed into topic points, and the topic points can be further divided in key lessons 232. The topics include professional and personal development areas. The professional development areas include business related topics such as leadership, business strategy, marketing, sales, accounting, law, human resources, technology, manufacturing, purchasing, logistics, finance, customer service, entrepreneurism and enabling technologies such as e-commerce. Personal development topics include athletics, entertainment, and religion. The structure of the database 120 preferably accommodates the portions of the key lessons 232 to correspond to a one-to-one or many-to-one ratio with topic points. The key lessons 232 may fall into different stages of the level of learning, such as, basic content and skills 234, the application of the content and skills 236 and an integration of content and skills with context and analysis 238.

To create the key lessons, the knowledge source 140 may perform one or more interviews 238a-n, and the one or more interviews 238a-n may be performed by multiple knowledge sources 140. For example, multiple knowledge sources 140 may speak or write to the same topic point. The topic points correspond to topics on a one-to-one or many-to-one ratio. Many topic points may be combined to make-up an entire topic, or one topic point may make-up the entire topic. To accommodate the above structure, the database 120 preferably allows for individual files containing the portions of information, for example topic points or key lessons 232, to be pulled from the database when the user enters criteria that correspond with that information. Additionally, the structure of the database 120 preferably allows multiple files from different learning lessons to be accessed and delivered as one learning lesson based on the criteria established by the user.

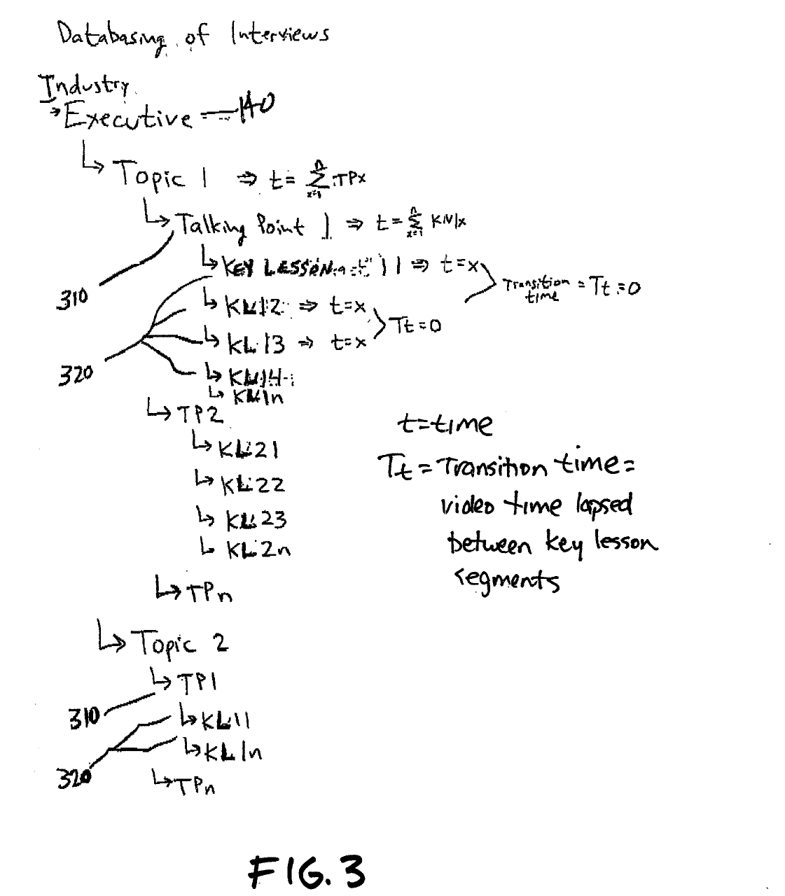

FIG. 3 is a diagram demonstrating one example of parsing and compartmentalizing the learning lessons in the database 120 to allow the user to customize a learning lesson. The learning system selects certain learning lesson segments from the database structure and ties the segments together if the user selects that path. Each learning lesson involves a knowledge source 140 associated with a particular industry or topic, and who speaks, writes or provides information on a particular topic. The topic of the learning lesson includes various points of discussion 310 and key lessons 320 that occupy a certain amount of time. The total time of the user chosen learning lesson equals the sum of all the time of the chosen key lessons 320.

Referring again to FIG. 2, at block 240, phase II of the control map 200 includes post-leaning testing. As part of the post-learning testing, the user may complete a test during or soon after completing the content phase of block 230. Thereafter, the user may also practice newly learned skills, for example in a work environment, and complete late-stage post-tests. In accordance with test results and the success level achieved in practicing the newly learned skills, the user may adjust the learning objectives in future uses of the learning system. Additionally, at block 250, the learning system can accommodate learning constructs, e.g., leadership and strategic thinking, by analyzing user needs, reviewing past interviews and acquiring and analyzing specific requests from the users, as described below.

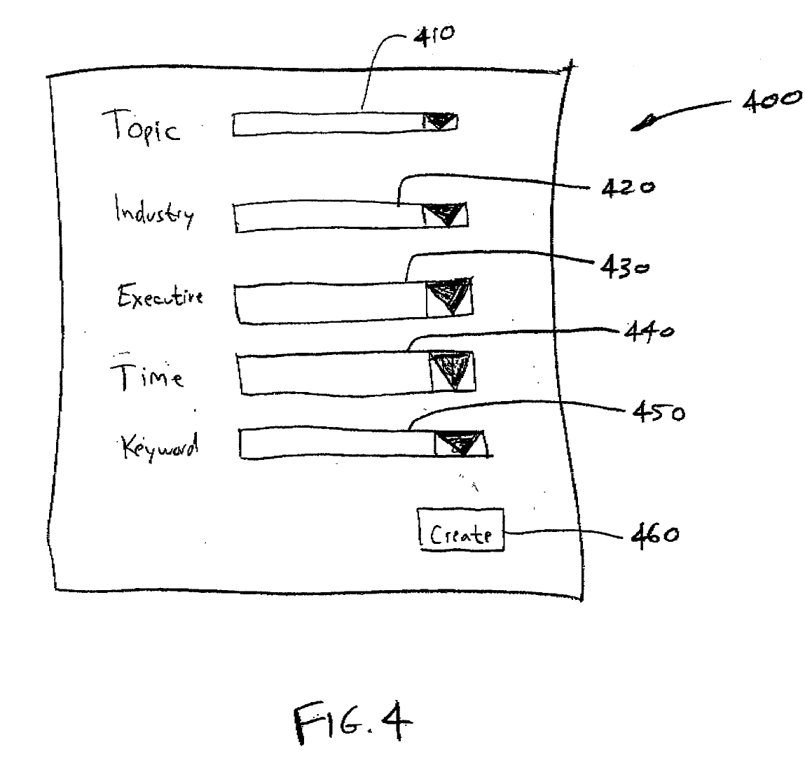

FIG. 4 illustrates a criteria computer terminal screen shot 400 where the user inputs specific criteria to create a learning lesson. The criteria that the user may select include a topic of the learning lesson 410. The criteria may also include the industry delivering the learning lesson 420, for example, the telecommunications industry. The criteria also includes a name, for example, the name of the executive conducting the learning lesson 430. Also, the user may be queried as to the user's available time to participate in a particular learning lesson 440. Other criteria may include the keywords that the user is interested to learn about through the learning lesson 450. The keywords relate back to the key lessons 320 learned from each learning lesson as described in FIG. 3.

To facilitate customizing a learning lesson to the user, the learning lessons are parsed in the database 120 as described above. To parse the learning lessons, the video of the learning lesson is divided into segments after completion of the video. Each segment is preferably associated with a topic, industry, executive, time element, and series of key words in accordance with the key lessons from the particular video segment.

Referring also to FIG. 1, the user choices can be displayed on the monitor 160 of the user terminal 150. The user can select a user option by using an input device such as the keyboard 170 and/or the mouse 180. The user choices can be available in a pull down format that is commonly used with an operating system like MICROSOFT WINDOWS or MACINTOSH. After the choices have been made, the user selects the create button 460 to enter the choices.

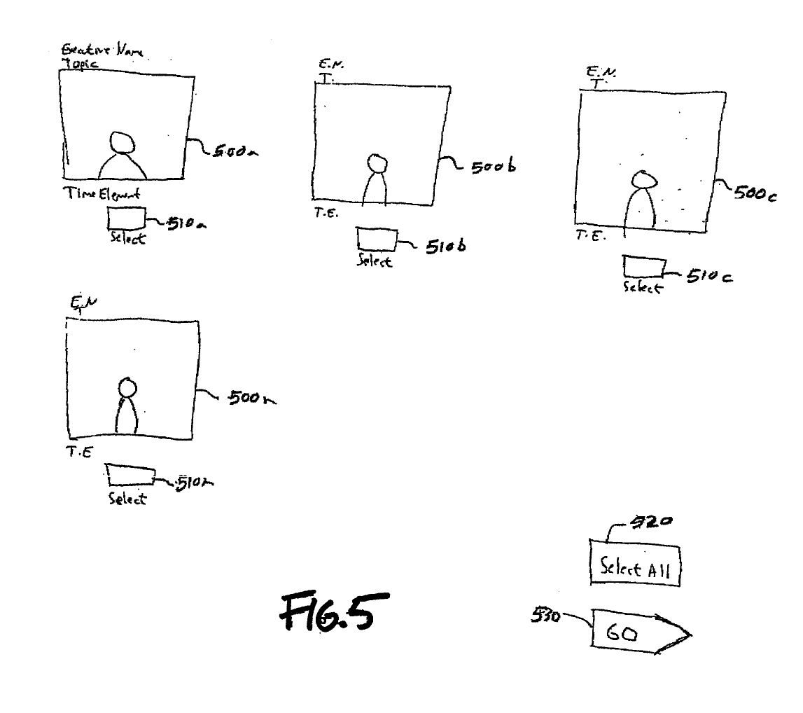

FIG. 5 is an exemplary screen shot demonstrating options a user is presented after inputting the criteria to create the learning lesson. Because the learning lessons are compartmentalized in the database 120, after the user identifies the learning criteria, the user is presented with learning lesson segments 500a-n, whole or in part, of the learning lessons that meet the selected criteria. To further customize the learning lesson, the user may select one or some of the learning lessons by selecting individual select buttons 510a-n, or select all of the segments by choosing the select all button 520. In order to help the user select the learning lesson segments, each display preferably includes the executive's name, topic in which they spoke about, time length of the segment, and rating of the learning lesson segments by prior users in the learning system.

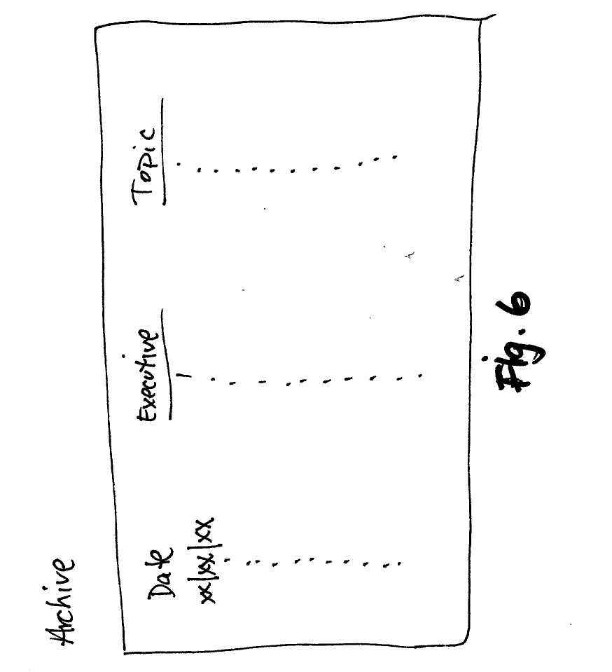

FIG. 6 is an alternate screen shot that demonstrates in tabular form the user's ability to select a learning lesson from an archive of learning lessons. The user may scroll through the list of lessons to identify the learning lesson in which they choose to participate. The user may alternatively choose to sort through the list by column heads. Referring again to FIG. 5, upon selection of the learning lesson segments, the user can choose the go button 530 and proceed to a screen shot for selection of a preferred learning method to conduct the learning lesson. Alternatively, the selection list is saved for later use.

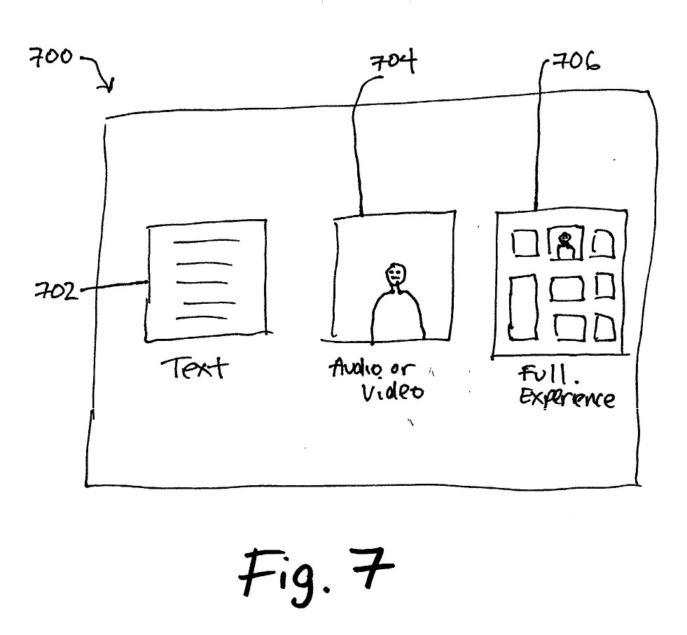

FIG. 7 is a learning method screen shot 700 illustrating user options to develop the learning criteria. Because all individuals learn differently, the user has the option to control to select a desired learning method. As shown, the user may select to read the learning lesson in text format 702, passively listen to and/or watch the learning lesson in audio/video format 704, or participate in an interactive learning lesson 706, described below.

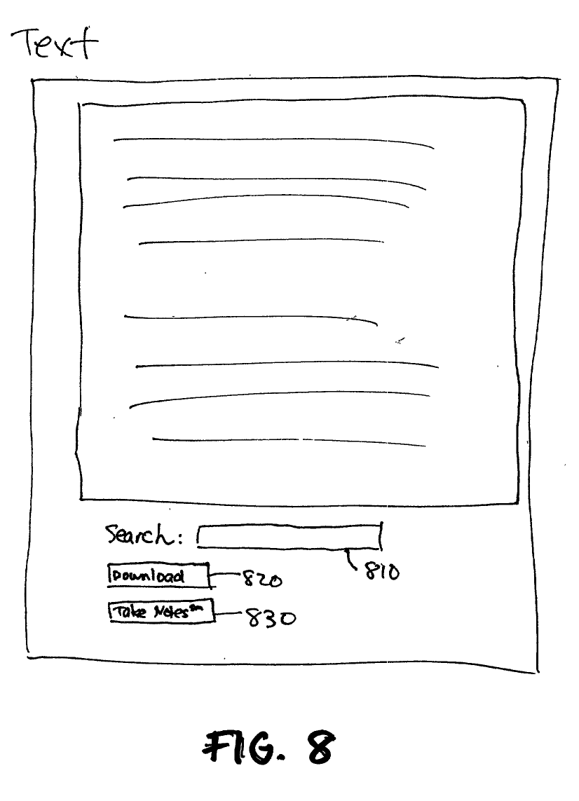

FIG. 8 is a screen shot that demonstrates the learning system once the user selects to participate in the learning lesson via reading. The user is able to read at any pace, as well as search the text for desired information using a search field 810. The search feature includes a database with terms found in the text. Alternatively, the reading time is limited. The user may also select to download the text 820 of the learning lesson for viewing at a later time, as well as share information by selecting a note-taking feature 830. The information may be shared with themselves, a defined group, or other individuals.

Upon completion of a lesson, the user will have the option to participate in an assessment to determine the actual amount of information learned, as well as develop an action plan with implementation goals for use of the information in the workplace.

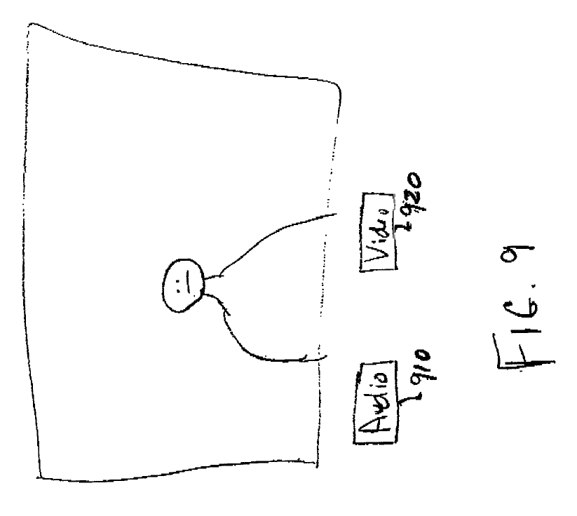

FIG. 9 is a screen shot that demonstrates the learning system once the user selects to participate in the learning lesson via passive audio and/or video format 704. The user selects whether to listen 910 to the learning lesson or watch and listen 920 to a video of the knowledge source 140. Upon completion of the lesson, the user will have the option to participate in an assessment to determine the actual amount of information learned, as well as develop an action plan with implementation goals for use of the information in the workplace.

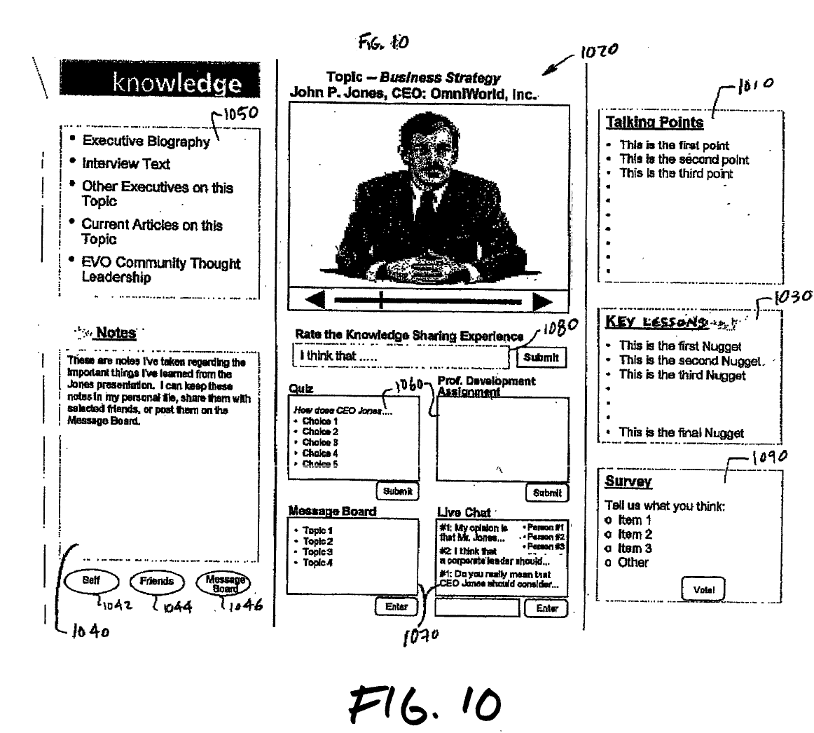

FIG. 10 is an exemplary screen shot that demonstrates the learning system when the user selects to participate in the interactive learning lesson 706. While participating in the interactive learning lesson 706, the user preferably can choose from a plurality of options for interactions.

Block 1010 include points of discussion, for example, topics and/or questions to be discussed during the learning lesson within the interactive learning lesson 706. An instructional designer, or creator, of the learning lesson preferably defines the topics and points to be discussed. A particular topic is combined with the experience of the knowledge source 140 to create relevant points of discussion.

The learning system allows the user to determine before viewing the learning lesson whether to include certain topics, preferably in accordance with the user's prior knowledge and skills. As previously described with regard to FIGS. 1 and 3, the database 120 is structured to accommodate division of the topics. Once the learning lesson begins, the user views the topics that will be discussed during the learning lesson and can select the topics relevant to the user based on the user's learning objective. During the learning lesson, the user may select to jump to another topic of the learning lesson or move back to cover a topic already discussed. The topics discussed during the learning lesson are preferably highlighted as the user picks the topic so that the user can identify which topics the user has reviewed.

Block 1020 illustrates a diagram of the video featuring the knowledge source 140, for example, the instructor or executive, during the learning lesson within the interactive learning experience. The video is stored at the control center 110, e.g., a remote server location, and streamed using broadband technology components. The video may also be stored at a local server location and streamed using broadband technology. Alternatively, the video may be stored at a local server and downloaded onto the learner's terminal 150. At the user terminal 150 the user can control certain technical elements of the video, including volume and display features.

Block 1030 illustrates a diagram of the key lessons learned from the knowledge source 140 during the learning lesson within the interactive learning experience. The key lessons are preferably determined by the instructional designer, or creator, of the learning lesson and are preferably displayed in synchronization with the video. The key lessons reinforce the spoken word of the knowledge source 140.

During the learning lesson, the users may select, or click-on, a specific key lesson to communicate the lesson to themselves or others. Clicking on the key lesson activates a communication mechanism or note taking section 1040 of the interactive learning lesson. In the note taking section 1040, the user can input text information that will be transmitted, for example, via electronic mail to themselves 1042, one or multiple sets of defined groups, such as friends 1044 inside and outside of the learning system, or with the at-large community 1046 of the learning system. The user can also attach and send the key lesson to themselves or others, such as individuals or defined groups.

The user may establish the defined groups prior to participation in the learning system. While inputting user information, such as prior knowledge and current skill level for topics, the user may identify individuals for inclusion in a group for communication, or knowledge sharing, purposes. The user can also establish whether the notes taken and distributed will accumulate until an end of the learning session.

Block 1050 illustrates a background and research area where the user can select supplemental information during the learning lesson within the interactive learning experience. The user preferably has one or more options to research supplemental information on the topic discussed in the learning lesson. The background and research is preferably compiled by the instructional design team and input into the database 120 that responds to the topic of the learning lesson.

Examples of the information contained in the background and research section include biographies of the knowledge source 140. Information could appear in a popup window when selected. Other available information can include fully downloadable text of the learning lesson and a list of other knowledge sources 140 who have delivered learning lessons on the same or a similar topic. Other information could include articles on the same topic as the learning lesson and articles written by other members of the at-large learning system community on the same topic. The articles submitted by other members may be viewed as thought leadership ideas as determined by other users. Both users of the learning system and non-users can submit the articles.

Blocks 1060 illustrate an assessment and implementation section within the interactive learning experience. In the assessment and implementation section, the user may determine to participate in a quiz, or assessment, to determine the amount of retention, or mastery, of the key lessons learned during the learning lesson. The instructional designer, or creator, of the learning lesson can develop the assessment. The results of the assessment may be submitted to the instructor or other individuals, such as the user's employer or a continuing education entity. Thereafter, an instructor or the user, for example, can analyze the results. The results can be used to evaluate the user's understanding of the material to determine paths for the user to pursue to progress in understanding the material.

The assessment and implementation section also includes an area for the user to determine how they will implement the lessons learned from the learning lesson into their daily responsibilities, including work responsibilities. The user identifies how participation in the learning lesson enhanced their understanding of the particular topic of the learning lesson and how lessons learned can be applied to the user's professional and personal development objectives. The assessment and implementation section also preferably includes a follow-up, or monitoring tool, to ensure that the lessons learned are retained by the user upon completion of the learning lesson for a period of time.

The monitoring tool includes multiple forms of assessment of retained information and implementation steps in daily tasks, including workplace tasks. Quizzes are one form of post-lesson monitoring. A quiz may be sent to the participant of the learning lesson via e-mail where the learner must complete the quiz and return to the lesson administrator for evaluation. Another form of monitoring tool includes written assignments where the user explains steps the user has taken to implement the key lessons learned from the learning lesson into the user's daily responsibilities. The results from both forms of monitoring tools can then be compared to stated objectives (described in Block 220, FIG. 2).

Blocks 1070 illustrate threaded discussions and live chats allowing the user to communicate with other individuals during the learning lesson within the interactive learning experience. The user may elect to participate in a threaded discussion regarding the topic of the learning lesson, or other topics, while simultaneously participating in the learning lesson. The threaded discussion tool helps address the non-linear manner in which people learn.

The live chat section allows the user to be alerted when a defined individual accesses the learning system to engage in real-time discussion on the topic of the learning lesson or other topics. This section also provides real-time information sharing during synchronous learning lessons. The user defines the individuals prior to the user's entry into the learning system. It can be appreciated, however, that defined individuals can be added or deleted at any time. In addition, some live interviews may allow the user to submit a question to the knowledge source 140 as well as pass information to other live interview members.

Block 1080 accommodates a rating feature that allows the user to evaluate the learning experience during the learning lesson within the interactive learning experience or after. In accordance with a defined scale, the user selects a number that corresponds to the value the user received from the learning lesson. The user may also include text. Such information could help future users decide whether or not to include the learning lesson as part of the learning experience.

Block 1090 illustrates a survey feature allowing the user to provide input to the provider of the learning lesson during the learning lesson within the interactive learning experience. The creator of the learning lesson preferably uses the information from the survey and/or the evaluation to determine learning behaviors and other topics in which to provide future learning lessons. The survey can also be used in other ways such as to determine future speakers and to determine thought leadership articles.

The foregoing detailed description has been provided by way of explanation and illustration, and is not intended to limit the scope of the appended claims. Many variations in the presently preferred embodiments illustrated herein will be obvious to one of ordinary skill in the art, and remain within the scope of the appended claims and their equivalents.

I claim:

1. A method for providing information to a user that connects to a network via an interface, the method comprising:
allowing the user to customize a learning lesson, wherein the learning lesson is provided over the network.

2. The method of claim 1 further comprising:
querying the user to select the learning style or a portion of a learning lesson on a topic; and
providing the learning lesson or the portion of the learning lesson to the student via the interface.

3. The method of claim 2 further comprising:
providing a database that contains a list of leaning lessons and portions of learning lessons;
providing the user an interface for access to the database; and
allowing user access to the list of learning lessons and portions of learning lessons.

4. The method of claim 2 wherein selecting the learning lesson or portion of the learning lesson further comprises first selecting at least one of an industry, a name, a topic and a key word.

5. The method of claim 2 wherein the learning style is selected from the group consisting of video, text, both text and video, and an interactive experience.

6. The method of claim 2 wherein the topic includes at least one of a professional related topic and a personal development topic.

7. The method of claim 6 wherein the professional related topic is selected from the group consisting of leadership, business strategy, marketing, sales, accounting, law, human resources, technology, manufacturing, purchasing, logistics, finance, customer service, entrepreneurism and enabling technologies.

8. The method of claim 2 further including a communication link that allows the user to share knowledge with others.

9. The method of claim 1 further including monitoring results of the user after the learning lesson.

10. A user-controlled network based learning system, the learning system comprising:
an interface that allows the user to select a learning method for the user and the material relevant to the user; and
an interface for the user to select a previously developed learning lesson.

11. The learning system according to claim 10 wherein a form of learning method is selected from the group consisting of text, video and audio forms of learning methods, and wherein the user has the option of participating in an interactive learning lesson.

12. The learning system according to claim 11 further including:
a display connected with the system;
wherein the interface further allows the user to select relevant material within the learning lesson and the display displays data in accordance with the relevant material;
wherein the interface allows the user to select the displayed data to communicate the displayed data with at least one of the user, at least one defined individual within the system, at least one defined individual outside of the learning system, and undefined individuals participating in the learning system; and
wherein the interface allows the user to input information and communicate the information with at least one of: (1) the user, at least one defined individual within the system, (2) at least one defined individual outside of the learning system, and (3) undefined individuals participating in the learning system.

13. The learning system according to claim 10 wherein the interface further allows the user to create a customized learning lesson in accordance with a breakdown of already developed learning lessons and a criteria the user determines relevant to a desired learning objective.

14. The learning system according to claim 13 further comprising:
a learning system that evaluates a user understanding of material to determine paths for the user to pursue to progress in understanding the material.

15. The learning system according to claim 14 wherein the learning system monitors user understanding of the material for any time period after completion of a learning lesson.
